(19) United States
(12) Patent Application Publication
(10) Pub. No.: US 2005/0241712 A1
(43) Pub. Date: Nov. 3, 2005

(54) Insitu impedance heating for pipe wall repair

(76) Inventors: Richard Blackmore, Houston, TX (US); William Lapola, Magnolia, TX (US)

Correspondence Address: LAW OFFICE OF DAVID MCEWING, P.O. BOX 231324, HOUSTON, TX, 77023, US

(21) Appl. No.: 11/088,575

(22) Filed: Mar. 24, 2005

Related U.S. Application Data
(60) Provisional application No. 60/556,809, filed on Mar. 25, 2004.

(51) Int. Cl. F16L 55/16

(52) U.S. Cl. 138/98

(57) ABSTRACT

The apparatus and method for insitu repair of pipes and conduits of varying diameter is taught by the specification and drawings. The invention utilizes impedance heating techniques and devices that previously been used to heat the contents within pipes and tanks. The invention can be adapted to utilize AC circuit components place either within the interior diameter of the pipe or adjacent to the outer pipe surface. The apparatus and method can include use of thermal couples or other components to monitor temperature and control electric current. The device and method can be variably used with electrical isolation components and techniques.

### RELATED APPLICATION

This application claims priority to a provisional application Ser. No. 60/556,809 entitled “Insitu Impedance Heating For Pipe Wall Repair” and filed Mar. 25, 2004.

### BACKGROUND OF INVENTION

1. Field of the Invention

The present invention relates to an “insitu” method to repair cracks and other defects in electrically conductive pipes and conduits.

2. Background of the Invention

Pipes and conduits made from ferromagnetic materials and their alloys e.g., carbon steel, etc. are extensively used to convey, water, wastewater and hydrocarbon products, including oil and gas. Other metals and metal alloys are also used as pipes and conduits, e.g., copper. Over time, the pipe walls are subject to cracking and corrosion as well as other modes of deterioration. Many methods of repair have been devised over the last thirty years. Some of those repair methods include slip lining, pipe bursting, cured in place pipe lining (CIPP), fold and form thermoplastic lining, spot repairs, as well as the traditional removal/replacement of pipelines. Inasmuch as pipelines are often buried beneath the ground surface or covered by structural wall, floors and ceilings, repair methods requiring access to the pipe such as pipe replacement are disruptive and expensive.

The “insitu lining” repair of underground pipes has been one of the most effective alternatives to pipe “dig and replacement” for many years. Other methods have been developed for exterior repair utilizing the injection of polymer resin forming material proximate to the exterior of the pipe surface. There are a variety of limitations in each method, including difficulty in creating suitable reaction conditions for the formation of the interior lining or exterior coating. One of the significant limitations has been achieving a sufficient temperature to allow the reaction to efficiently proceed. Hot water, steam and hot air have variously been injected into the pipe to facilitate the curing of a thermally responsive reactant.

### SUMMARY OF INVENTION

The invention subject of this specification teaches insitu pipe repair methods utilizing thermally responsive polymer resins with heat generated by either direct or inducted electric currents within the electrically conductive pipe wall. This technology allows a broader range of reactants to be utilized. It also allows the reactants to be selected or modified depending upon the electrical properties of the pipe wall.

The heat produced within the pipe wall by the methods and apparatus of this invention also facilitates the curing of reactants, thereby allowing the use of styrene free thermosetting or thermoplastic resins. These resins may be impregnated within a fibrous reinforcing repair material, i.e., an impregnated (“prepreg”) composite repair material, placed proximate to the pipe wall. The thermally responsive composite can be cured with the heat created within the pipe wall.

The invention also teaches the use of this technology in combination with the injection of chemical reactants creating expanding closed cell foam (“foaming liquids”) for stabilization of the surrounding ground proximate to the underground pipes. The heat assisted CIPP mechanisms and techniques for interior pipe repair thereby allow the use of more environmentally friendly foaming liquids than feasible in ambient conditions to stabilize the ground surrounding the pipe and achieve exterior repair of the pipe wall. The invention can provide a heat source for curing of the resin of the prepreg repair materials, closed cell foaming liquid resin and limiting resin redistribution.

Other benefits of the invention will also become apparent to those skilled in the art and such advantages and benefits are included within the scope of this invention.

### BRIEF DESCRIPTION OF THE DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1 illustrates the structure and typical defects of a pipe.

FIG. 2 represents a cross sectional view of a defective pipe.

FIG. 3 represents an embodiment of the invention oriented externally to the pipe with a pipe patching component internally located within the pipe diameter.

FIG. 4 illustrates an embodiment of the invention oriented internally to the pipe and having multiple parallel impedance circuits.

FIG. 5 illustrates a collapsible and inflatable bladder containing the electrical connecting components for creation of impedance heating.

FIG. 6 illustrates another embodiment having a plurality of internal oriented parallel impedance circuits.

FIG. 7 illustrates the parallel orientation of the pipe wall circuit component and the circuit connector.

FIG. 8 illustrates a cross sectional view of the pipe wall and two circuit connectors.

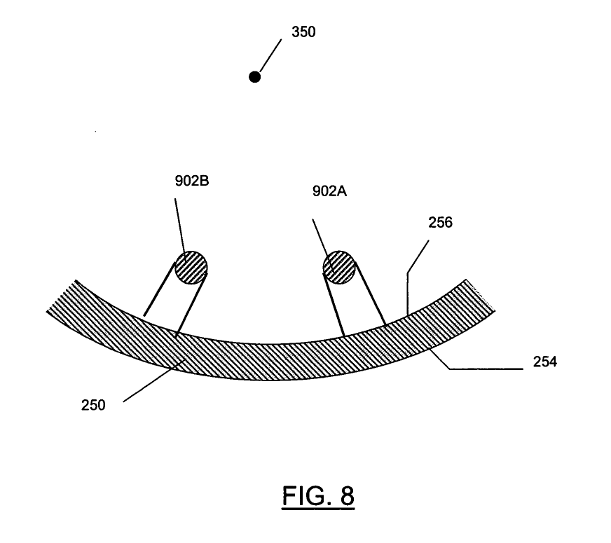

### DETAILED DESCRIPTION OF THE INVENTION

The above general description and the following detailed description are merely illustrative of the subject invention and additional modes, advantages and particulars of this invention will be readily suggested to those skilled in the art without departing from the spirit and scope of the invention. The teaching of this invention will be understood to be applicable for both the repair and support of pipe connecting interface, as well as for linear and non-linear pipelines.

The invention utilizes electromagnetic properties of the pipe material in conjunction with an applied electric or induced electric current. In the embodiment of the applied current, the electrical conductive connectors are attached to the pipe wall. An electric current is passed through the wall. Depending upon the properties of the electric current, a heat of resistance is generated within the wall.

If a DC current is applied, the quantity of heat will be a function of the pipe material, the quantity of the pipe (thickness and diameter) and voltage and amperage. For a pipe of a given material e.g., carbon steel, and subjected to a current of fixed voltage or amperage, the conductive volume of the pipe will determine the quantity of resistive heat generated.

If an AC current is applied to a pipe of a given material e.g., carbon steel, the effective resistance of the material will determine the quantity of heat generated. The effective resistance will be a function of the frequency of the AC current. The higher the frequency the will increase the skin effect and effective resistance. It will be appreciated by persons skilled in the art that as the frequency of an AC current is increased, the rate of change of flux increases, which, in turn, increases the counter EMF within the conductive pipe wall. This counter EMF will cause the AC current to flow closer to or at the surface of the electrically conductive pipe wall. As the relative quantity of the AC current increase at the surface, the effective cross sectional area of the pipe is greatly reduced, and therefore, the effective resistance of the pipe wall is increased (and much greater than the comparable DC ohmic resistance).

It will therefore be appreciated that the properties of the electric current can be adjusted with the conductive mass and material type of the pipe to create (or induce) the desired quantity of heat for a given range of electric power.

It will further be appreciated that the invention teaches the use of AC current to induce an electric current within the pipe wall. The induced current, i.e., eddy current, is also able to create resistive heat similar to that created by the applied AC current. An advantage of utilizing induced electric current is that electrical contact with the pipe surface is not required. This can be important if the proximate pipe surface has been corroded, contains an existing coating or is covered with a material residue.

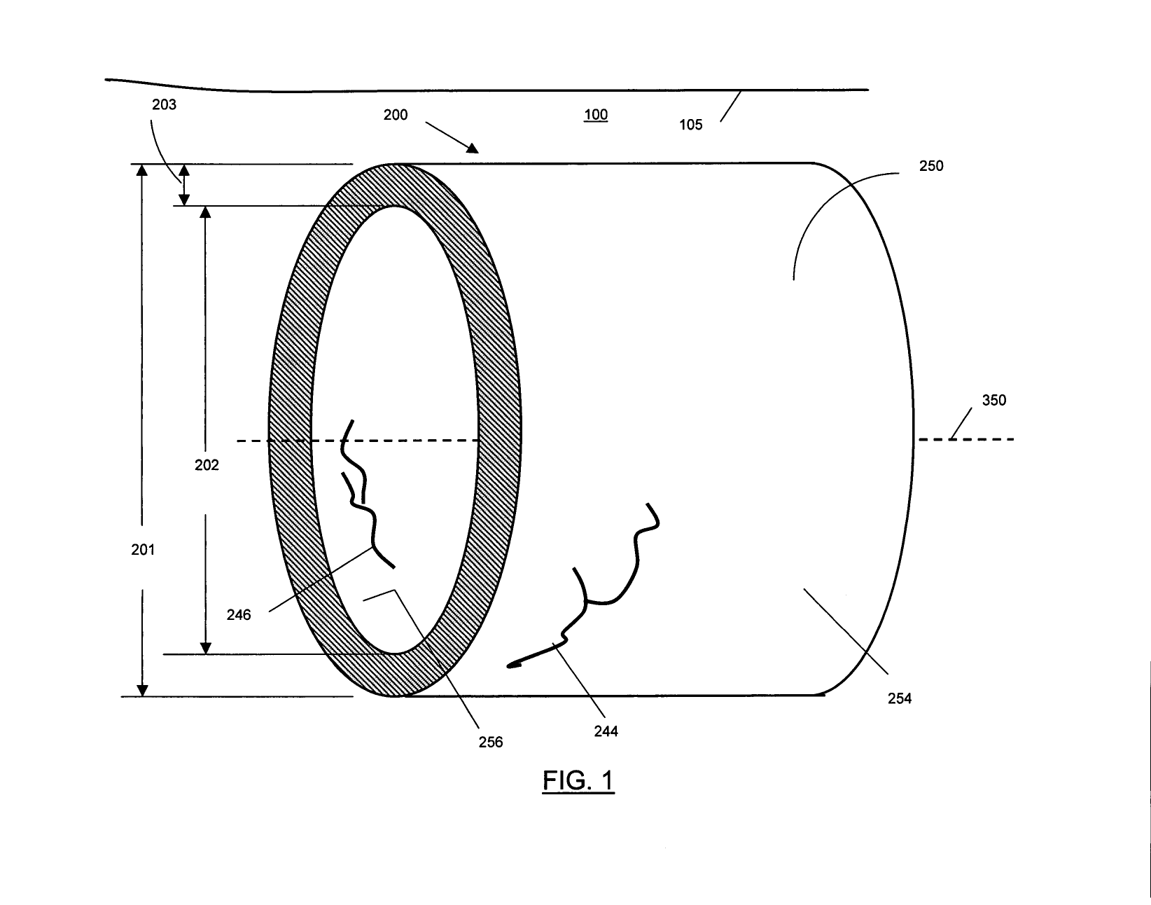

FIG. 1 illustrates typical pipe configuration that can be the object of repair by the method and apparatus of this invention. The pipe 200 has an outer diameter 201 and an inner diameter 202. The thickness 203 of the pipe wall 250 will of course be a function of the outer and inner diameters. The pipe wall thickness and circumference will determine the electrically conductive cross sectional area. The effective cross sectional area, as discussed above, will also be a function of the properties of the electric current and skin effect.

The pipe also has a longitudinal axis 350. It will be appreciated that the pipe may be buried within the ground 100 beneath the ground surface 105. In other situations, the pipe may be within a building wall or ceiling or buried beneath a floor. The pipe may be accessible through various ports such as manholes (not shown).

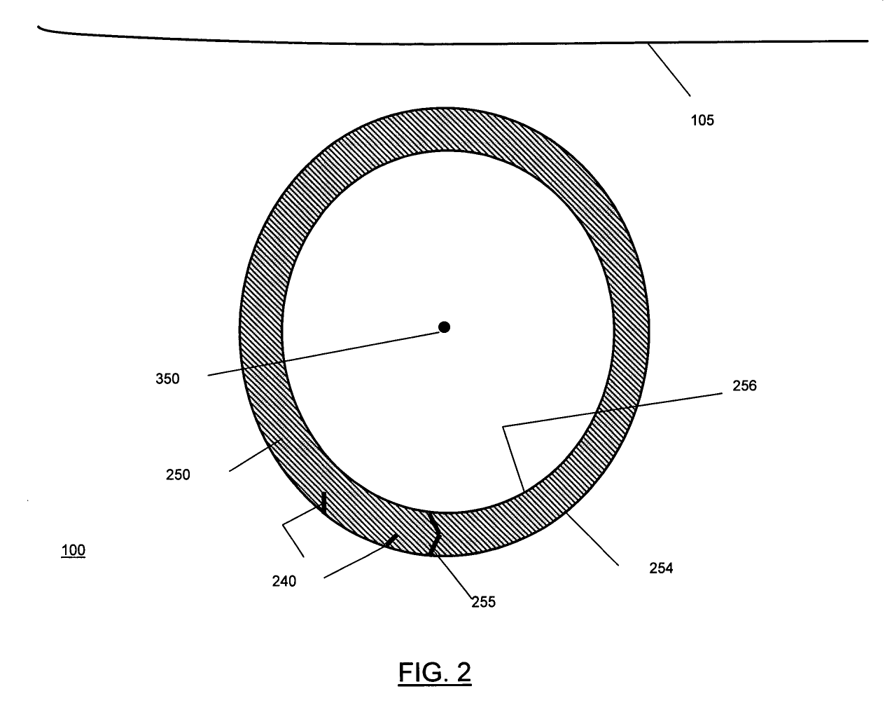

FIG. 2 is a cross sectional schematic of the pipe 200 along the longitudinal axis 350. The pipe thickness 203 is also illustrated. The pipe 200 is located beneath the ground surface 105. Also illustrated is the pipe diameter 202 and cracks 240 and voids 255 through the thickness 203 of the pipe wall 250. It will be appreciated that the voids intended to be remedied by the subject invention need not be of the large size depicted in these illustrations. Further, it will be appreciated that the subject invention is not limited to repair holes or cracks in pipes, but can be used to seal connections (or “couplings”) between pipe segments, or between pipe lines, e.g., a pipe connection or junction. Additionally, the invention can be used in fundamentally sound pipes and conduits where a layer of material may be desirable to prevent corrosion or decay. Pipes that may benefit from this invention can range from large diameter sewer/water pipes, hydrocarbon processing pipes and small diameter (e.g., ⅜ inch) piping and tubes.

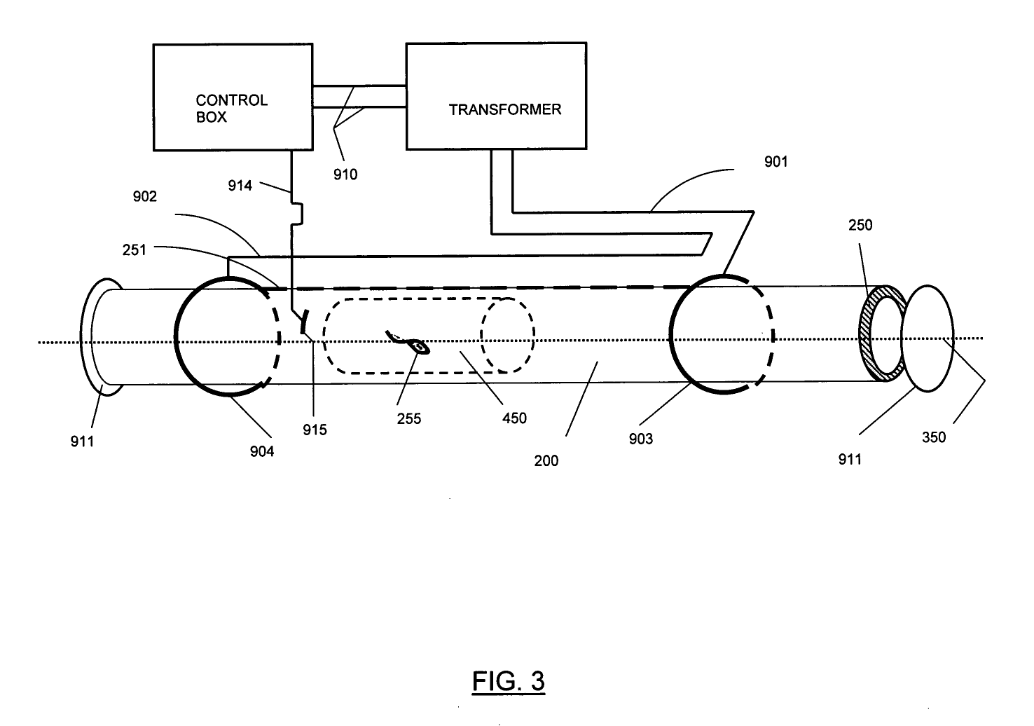

FIG. 3 represents an embodiment of the present invention wherein the electrically conductive components 903 904 are attached on the exterior of the pipe 200. For clarity of the illustration, the connective components are shown to be not in contact with the pipe surface. However, it will be appreciated that the components are to be in electrical contact with the outer surface 254 of the pipe wall 250.

The pipe wall contact components 903 904 are also not required to circumference the outer pipe surface. Rather a single point contact may be utilized. The contact points are electrically connected by conductive means 901 902 to a transformer. The transformer permits the AC current voltage to be lowered. This lowered voltage can have additional attributes for the operation of the invention with minimal site preparation. It will be appreciated that the lower voltage potential can reduce concern and prevention of circuit grounding. FIG. 3 illustrates optional use of dielectric insulator devices 911 to isolate the pipe section subject of the repair from the continuous pipe length.

FIG. 3 also illustrates an orientation of the exterior circuit component 902 in relation to the energized electric circuit segment 251 of the pipe wall 250. This configuration achieves AC current flowing in a series connected inner pipe wall segment 251, through to contact component 904 to the exterior component in substantially parallel orientation and proximity.

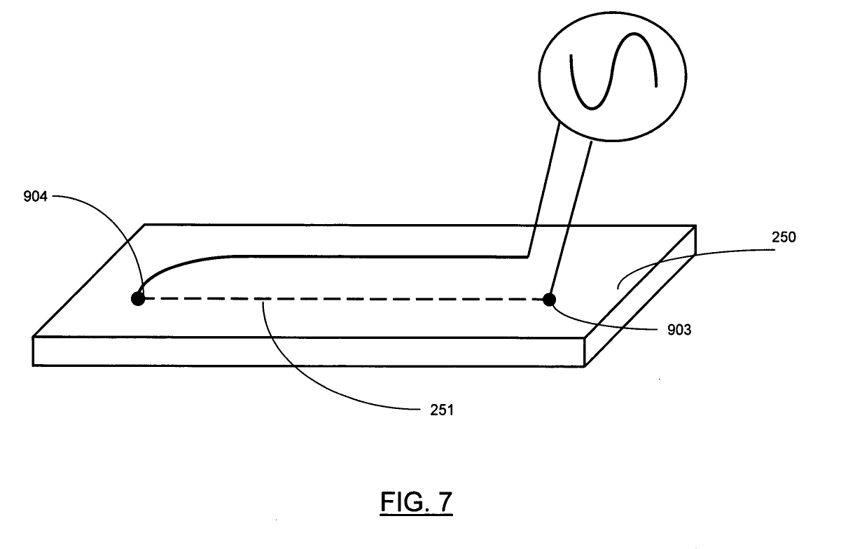

FIG. 7 illustrates a basic orientation of the components utilized for impedance heating, particularly a section of pipe wall 250 (here illustrated as an flat plate) a first contact component 903, a energized electric circuit pathway 251 within the pipe wall 250, a second contact component 904 and the substantially parallel electric connector means located proximate to the pipe wall surface and returning to the AC power supply.

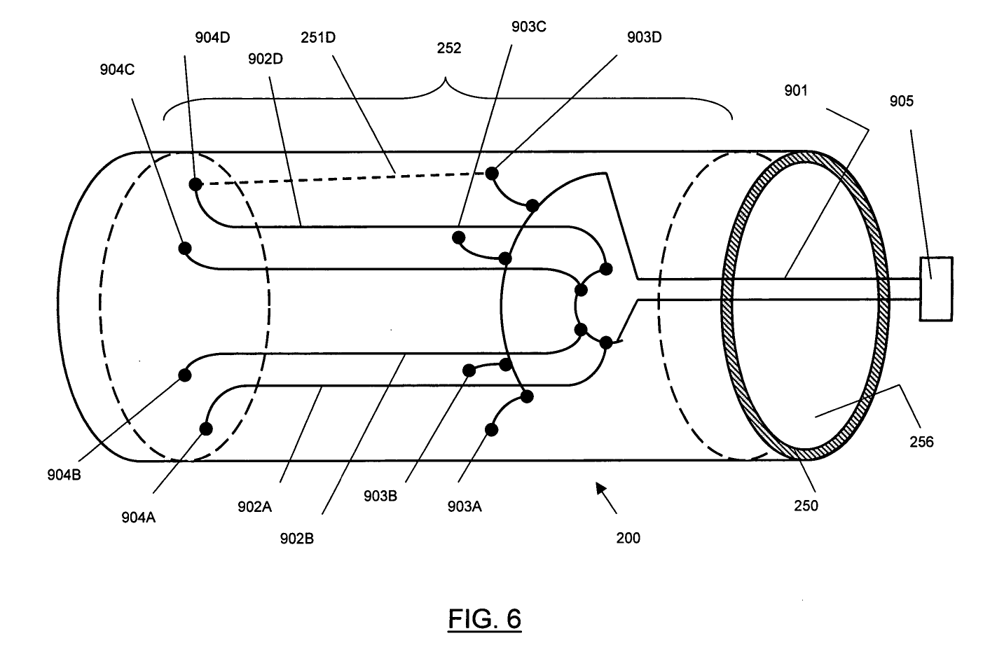

When the AC power is supplied to the transformer (which reduces the voltage), alternating current flows in the series connected components such as the outer conductor and through the connecting component to the inner pipe wall surface 251. The circuit creates impedance heating. The single circuit can be utilized of the impedance-heating unit, basically shown in FIG. 7, or with multiple parallel oriented impedance heating circuits as illustrated in FIG. 6.

Again, FIG. 6 illustrates four parallel impedance circuits heating a zone 252 of the pipe 200. Illustrated is the transformer 905, an electrically conductive cable or wire 901, a conductive component connecting the first contacting components 903A 903B 903C 903D conductively attached to the inner pipe wall 250 surface 256. The second contacting components 904A 904B 904C 904D are conductively attached to the parallel oriented component 902A 902D, thereby completing the circuit. One internal pipe wall circuit component is also illustrated 251D.

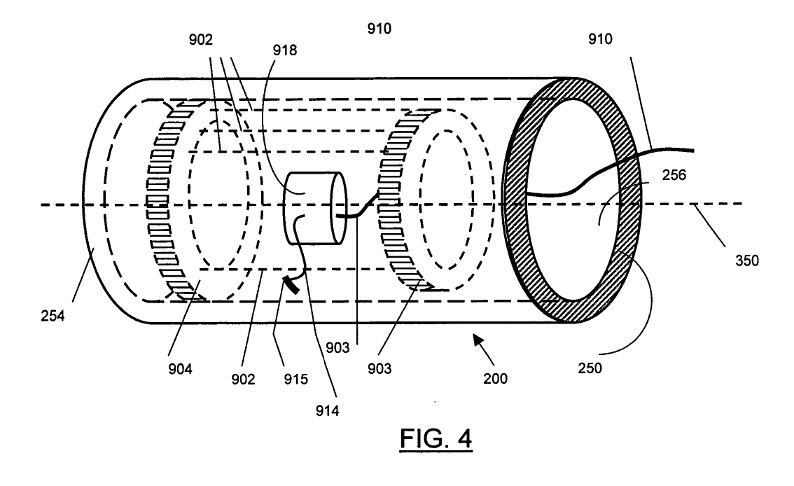

FIG. 4 illustrates another embodiment with the component oriented within the interior of the pipe. The two circuit connectors 903 904 in contact with the interior pipe wall surface 256. Also illustrated is a thermocouple component 915 in electrical communication 914 with transformer and control unit component 918. This component is electrically connected 910 to a separate power source and control. Several of the circuit components 902 oriented in parallel to the internal pipe wall circuit component are also illustrated.

Impedance heating systems are capable of producing substantial heat within storage tanks and pipelines. Resistance (I²R) heating develops when current flows in the pipe wall. The effective resistance of the pipe varies based upon pipe length, composition and wall thickness. If material within the pipe is electrically conductive, (e.g., water or wastewater), the resistive load further increases. The rapid change of a 60 Hz AC current induces an electromotive force and self-inductance that opposes current flow (reactance). The reactance combines with the resistance to further impede current flow and generate heat. Magnetic flux coupling between current paths in the impedance heating system also produces heat due to hysteresis (molecular friction) and eddy currents.

When the AC power is supplied to the transformer 905, (which reduces the voltage), alternating current flows in the series connected pipe wall segment 251 and the proximate, parallel oriented connector 902. It will be readily appreciated by persons skilled in the technology that an AC current flowing through a conductor will be concentrated on the surface of the conductor. This phenomena is typically described as the “skin effect”. The depth of the skin effect current flow is in relationship to the resistivity of the conductor material i.e., pipe wall material (measured in ohms per centimeter), the permeability factor of the material and the frequency of the current in cycles per second.

Further optimal orientation of the conductive components can achieve current flow on the inner pipe wall surface, resulting in minimal voltage appearing on the outer pipe wall surface. It will be appreciated that this outer pipe wall surface may be in contact with the ground. This utilization of skin effect can thereby minimize concern with loss or inefficiencies due to grounding of the circuit.

Because of the concentric parallel configuration of the components (illustrated particularly in FIG. 6), heating is the result of the resistance of the conductive material, i.e., pipe wall, but is enhanced by the reactance inherent in the system, the reactance being defined as the opposition to the self inductance caused by the rapid reversals in magnetic flux around the two conductors. Eddy currents and hysteresis also contribute to heat production.

The skin effect current tracing system has been used for heating of liquids and gases within tanks or within process pipelines. See U.S. Pat. No. 4,408,117, issued Oct. 4, 1983, Yurkanin; and U.S. Pat. No. 6,031,972, issued Feb. 29, 2000, Barker. Components utilized in these applications, and that can be adapted to the present invention, are known and commercially available from manufactures such as Industrial Engineering & Equipment Company (INDEECO) and Banner Engineer & Sales, Inc. These systems include low voltage transformers (80 volts or less).

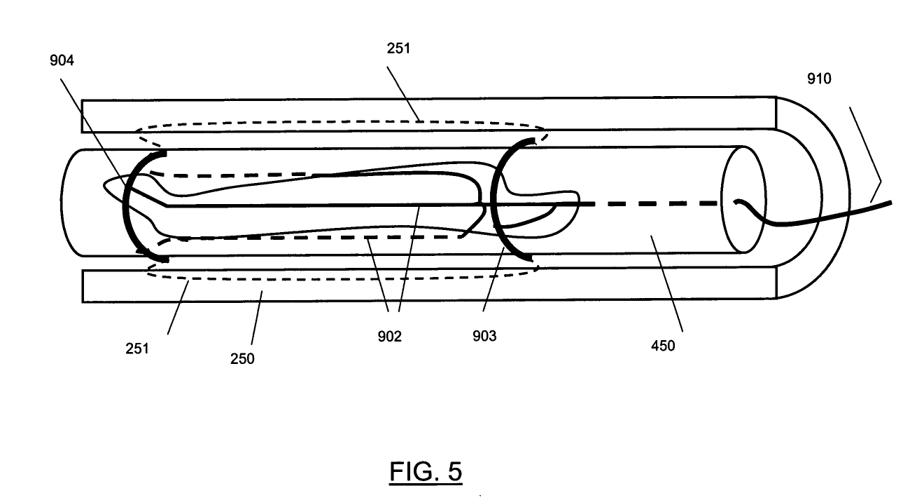

The invention subject of this disclosure also includes use with inflatable bladders containing electrically conductive elements that can be inserted into selection sections of pipes, including underground pipe or pipes located within wall, ceilings, etc. The electrically conductive components of the bladder can be in communication with a power source, including transformer and control panel located separately, e.g. at the ground level surface. The deflated bladder can be positioned within the pipe prior to inflation. When inflated, the outer surface of the bladder can be placed in contact with the inner pipe wall surface. The bladder can contain components that are electrically conductive, such as flexible carbon fibers. The bladder construction can orient the conductive surfaces and internal conductors to achieve a desired electrical contact and isolation relative to the pipe surface. When inflated, the conductors within the bladder may be energized, thereby creating a concentric electrical circuit incorporating a segment of the electrically conductive pipe wall. FIG. 5 illustrates a bladder 450 within a pipe interior 250 within the two connectors 903 904 with the internal wall circuit pathway 251. The interior connecting components 902 within the bladder wall are also shown and it will be appreciated that the component are electrically isolated from the pipe wall, but oriented proximate and parallel to the pipe wall 250.

The thermally responsive material may be pressed to the pipe wall surface by a tensioned pipe support device of the type disclosed in the co-pending application entitled “Tensioned Pipe Support”, Ser. No. 10/798,202 filed Mar. 8, 2004 and which is incorporated by reference herein.

It will be readily appreciated that the resulting inductive heating of the pipe wall can be used in combination with known thermally responsive chemical reactants, e.g., epoxy resin systems, to seal, repair or reinforce pipe wall structures insitu.

The combined and concurrent pressing of the resin impregnated fibers to the inner pipe wall surface with the heating of the pipe wall surface facilitating the curing of thermosetting resin for improved repair and support. The addition of heat, in contrast to ambient conditions, allows more rapid curing. Further, used in conjunction with the inflated bladder, the heat allows the bladder to serve as a mold pressing the repair material to the pipe wall for a greater portion of the cure and minimizes the degradation of the repair by resin redistribution. It will be appreciated that the use of the expanding and heatable bladder also minimizes the formation of “annulae” between the interior pipe wall surface and the liner.

Further, heat from the pipe wall is also available to radiate both inward or outward. When used to supply heat adjacent to the outer pipe surface and environment, the heated wall may facilitate the cure of the foaming liquid immediately proximate to the pipe wall. Curing of the foam creates a phase change in the foam to a closed cell solid. The closed cell foamed solid can compact the material proximate to the pipe, decrease voids or interstitial spaces, as well as support and seal the pipe and pipe junctions

The availability of the proximate heat source taught by this invention thereby also allows use of alternate reactants, including foaming agents not containing isocyanates. It will be appreciated that isocyanates are considered to be a source of environmental contamination. These alternate reactants include hybrid polyurethane or polyester/polyurethane blend resin, and epoxy resins combined with diluents, catalysts, blowing agents and surfactants, an acrylimide, and cementitous slurry.

Additionally, externally applied materials may be used when the piping system is exposed or “above-ground”. The benefits of heat, created within the exterior portion of the pipe surface can be employed to cause a phase change or cure of an externally applied material intended to enhance the mechanical properties or to provide a level of corrosion resistance.

It will also be appreciated that the AC circuit can be oriented relative to the outer pipe wall surface, i.e., the conductive and concentric or parallel component being located proximate to the outer pipe wall surface.

1. A method for insitu repair of electrically conductive pipes comprising the following steps:
a. creating an electric current within a pipe wall;
b. using electrically resistive properties of the pipe wall to create heat within the pipe wall;
c. applying a thermally responsive material proximate to a surface of the pipe; and
d. utilizing the heat to cure or mold the thermally responsive material.

2. The method of claim 1 further comprising the step of creating an electrically conductive connection between the pipe wall and an electrical power source.

3. The method of claim 2 further comprising conducting DC current from the power source to the pipe wall.

4. The method of claim 2 further comprising conducting an AC current from the power source to the pipe wall.

5. The method of claim 4 further comprising utilizing a thermal setting material as the thermally responsive material.

6. The method of claim 5 wherein the thermal setting material is selected from a group consisting of phenolics, amino-formaldehydes, esters, epoxides, polyamides, and polyurethanes.

7. The method of claim 4 further comprising utilizing a thermal plastic material as the thermally responsive material.

8. The method of claim 7 wherein the thermal plastic material is selected from a group consisting of polyethylenes, polyolefin copolymers, polyvinyl chloride, polytetrafluoroethylene, polystyrenes, acrylic, polyamides, saturated polyesters, polycarbonate, polyacetal, polyphenylenes, and polysouphones.

9. The method of claim 2 wherein the thermally responsive material is placed on an inner surface of the pipe.

10. The method of claim 2 wherein the thermally responsive material is placed on the outer surface of the pipe.

11. The method of claim 9 further comprising the step of using an inflatable bladder with the placement of the thermally responsive material.

12. The method of claim 1 further comprising the step of using a tensioned pipe support with the placement of the thermally responsive material on the pipe wall surface.

13. The method of claim 10 further comprising the step of injecting a foaming liquid reactant proximate to the exterior of the pipe.

14. The method of claim 1 further comprising the steps of
a. Placing an electrically isolated AC circuit proximate to the pipe wall;
b. Powering the electric circuit; and
c. Inducing the electric current within the pipe wall.

15. A method for insitu repair of electrically conductive pipes comprising the following steps:
a. Inducing an AC electric current within a pipe wall;
b. Using electrically resistive properties of the pipe wall to create heat within the pipe wall;
c. Applying a thermally responsive material proximate to a surface of the pipe; and
d. Utilizing the heat to cure the thermally responsive material.

16. An apparatus for repairing pipes comprising:
a. a first electrical contact component removably attachable to a pipe wall;
b. a second electrical contact component removeably attachable to the pipe wall; and
c. an electrically conductive component in electric communication with at least one electrical contact component and connectable to an electric power source.

17. An apparatus for repair pipes by inducing an electric current within a portion of an electrically conductive pipe wall to create heat that can mold or cure a thermally responsive repair material comprising an electric circuit component that can be placed proximate to a pipe wall surface and connectable to an AC power source.

18. The apparatus of claim 17 wherein the electric circuit component is attached to an inflatable bladder.

19. The apparatus of claim 17 wherein the electric circuit component is embedded with an inflatable bladder.

20. The apparatus of claim 17 wherein the electric circuit component is attached to a tensioned pipe support.
